(19) United States
(12) Patent Application Publication
(10) Pub. No.: US 2003/0057074 A1
(43) Pub. Date: Mar. 27, 2003

(54) Contact arrangement for a grounding switch in switchgears which are provided for supplying and distributing power

(76) Inventor: Rainer Poth, Bad Vilbel (DE)

Correspondence Address: MORRISON & FOERSTER LLP, 2000 PENNSYLVANIA AVE, NW, SUITE 5500, WASHINGTON, DC, 20006-1888, US

(21) Appl. No.: 10/182,381

(22) PCT Filed: Feb. 7, 2001
(86) PCT No.: PCT/DE01/00531

(30) Foreign Application Priority Data
Feb. 8, 2000 (DE) 10006821.9

(51) Int. Cl. H01H 1/06

(52) U.S. Cl. 200/275

(57) ABSTRACT

The invention relates to a contact arrangement for a grounding switch in switchgears which are used for supplying and distributing power, especially for a fault initiating switch in medium-voltage switchgears, with two contact members which can move in relation to one another and of which first contact members are provided as blade contacts and other contact members are provided as adjacent gripping contacts that are composed of U-shaped contact lamellae. During contacting, said gripping contacts are connected in an electrically conductive manner to the outer contours of the blade contacts. The blade contact is formed by a contact rod (KS) preferably having a round cross-sectional contour and is delimited on both ends by a guide pin (FB) which protrudes beyond the cross-sectional contour and which is provided with a guiding groove (FN). The guide pins (FB) are linearly guided with the guide grooves (FN) inside guiding slots (FS) of a housing wall (GW) that outwardly delimits the contact arrangement, whereby the contact rod (KS) is guided to the gripping contacts by a spreading link drive (SA) having contact pressure springs (KF). Grounding switches are used in switchgears provided for supplying and distributing power.

The invention relates to a contact arrangement for a grounding switch in switchgear assemblies for power supply and distribution, in particular for a fault making switch in medium-voltage switchgear assemblies, having two switching contacts which can move relative to one another, of which first switching contacts are in the form of a blade contact and further switching contacts are in the form of split contacts which are composed of U-shaped contact laminates, are arranged alongside one another and are electrically conductively connected to external contours of the blade contacts during the contact-making process.

A contact arrangement of the type defined in the introduction is known from DE 33 19 568 A1. The isolating switch, which is preferably in the form of a grounding switch, thus has two switching contacts which can move with respect to one another, and of which one is in the form of a blade contact and a further switching contact is in the form of a split contact. The split contacts are in this case formed from U-shaped contact laminates which are arranged alongside one another and against whose mutually opposite external contours the external contours of the blade contacts rest while contact is being made. The current-carrying capacity is in this case governed essentially by the number of split contacts which are arranged alongside one another and by the contour of the blade contacts which can be inserted between them. Shaped springs which are arranged in the contact region ensure the necessary contact pressure between the split contacts and the blade contacts. In order to further increase the current-carrying capacity of such grounding contacts, a number of split contacts located one behind the other are combined to form a contact laminates.

The object on which the invention is based is to considerably simplify the design of the contact arrangement of the type defined initially and, in particular, to increase the contact-making capacity and the contact pressure during the contact-making process. According to the invention, this is achieved by the following features:

1.1 the blade contact is formed by a contact rod which preferably has a round cross-sectional contour,

1.2 the contact rod is bounded at each of its two ends by a guide bolt which overhangs the cross-sectional contour and is in each case provided with a guide groove,

1.3 the guide bolts are linearly positively guided by the guide grooves in guide slots in a housing wall which provides the contact arrangement for the outer boundary,

1.4 the contact rod is moved toward the split contacts by means of a split link drive with contact pressure springs.

The replacement of the blade contacts by the coupling rod and its linear positive guidance within the guide slots in the housing wall creates, using simple means, a contact arrangement which can be subjected to major loads without damage and by means of which, by virtue of the split link drive in conjunction with the contact pressure springs, very high contact pressures are achieved between the contact rod and the split contacts. Furthermore, the arrangement and the mounting of the guide bolts in the housing wall which provides the outer boundary for the contact arrangement results in the grounding switch having a very compact construction, by means of which the contact pressure forces can be transmitted from the contact rod to the split contacts uniformly, without any special adjustment measures.

The round cross-sectional contour of the coupling rod further assists these uniformly distributed contact pressure forces over the entire contact arrangement.

One advantageous refinement of the invention is provided by the following features:

2.1 the split contacts are formed from at least one leading contact, and with a number of main contacts matched to the current load to be carried,

2.2 the split contacts are distributed in the contact arrangement such that ground potential can be supplied via the split contacts on the housing wall which provides the outer boundary, and the split contacts which are enclosed between them are used as pole connections.

This symmetrical arrangement of the split contacts ensures, in a simple manner, both the electrical conditions to withstand overvoltages and the mechanical loads with respect to the desired high contact pressures between the contact rod and the split contacts.

A further advantageous refinement of the invention is provided by the following feature:

3.1 the split contacts are matched to the cross-sectional contour of the contact rod such that, when the contact rod is moved toward the split contacts, recesses in the leading contacts make contact with the split contacts first of all, after which further recesses in the main contacts make contact with the split contacts.

This switching sequence results in the split contacts not being subjected to any greater risk of fire even in the event of short circuits, since first of all the leading contacts, which are associated with higher resistances, are loaded by the current flow, and the electrically conductive connection between the coupling rod, which is at ground potential, and the main contacts of the split contacts is produced only at a later stage.

A further advantageous refinement of the invention is achieved by the following features:

4.1 the recesses in the leading contacts surround the cross-sectional contour of the contact rod over half of its diameter,

4.2 the recesses in the leading contacts are asymmetric with respect to their longitudinal axis such that the upper part projects by an extension attachment beyond the lower part,

4.3 the further recesses in the main contacts surround the cross-sectional contour of the contact rod by means of contact webs, which run parallel to one another, while making contact,

4.4 the main contacts have a symmetrical contour with respect to their longitudinal axis.

The recesses in the leading contacts thus form a relatively large contact area, with a correspondingly high current load capacity, for the coupling rod. Furthermore, the extension attachment on the leading contacts ensures that, when contact is being made with the contact rod, the current flow necessarily first of all passes via the leading contacts.

In contrast, the symmetrical contour of the main contacts with their contact webs running parallel to one another offers reliable contact guidance for the contact rod within the split contacts.

A further advantageous refinement of the invention is provided by the following features:

5.1 the contact rod and the main contacts are produced from copper material,

5.2 the leading contacts are produced from sheet steel.

Both materials satisfy not only the electrical requirements but also the mechanical requirements for the grounding switches, and can be produced as stamped parts, and assembled like laminates, in a simple manner.

The invention will be explained in more detail by means of an exemplary embodiment which is illustrated graphically by means of three figures, in which

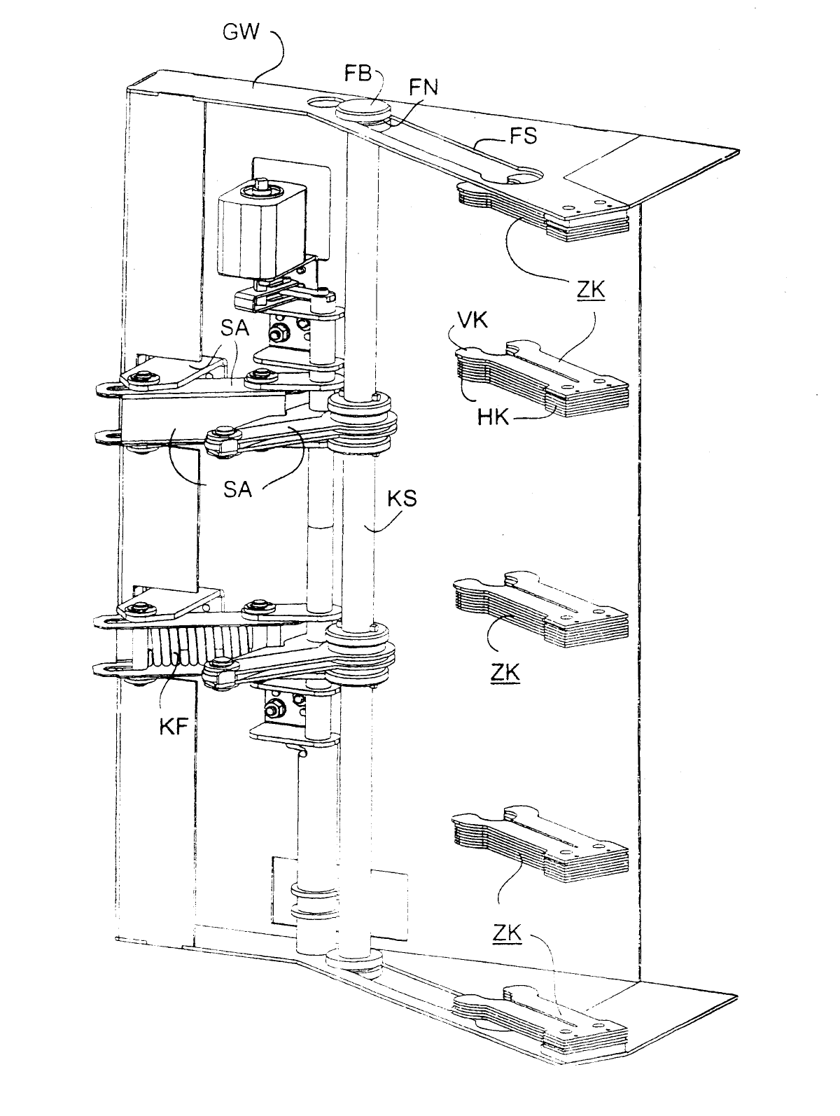

FIG. 1 shows one of the possible embodiments for the grounding switch with its contact arrangement, illustrated in perspective, and

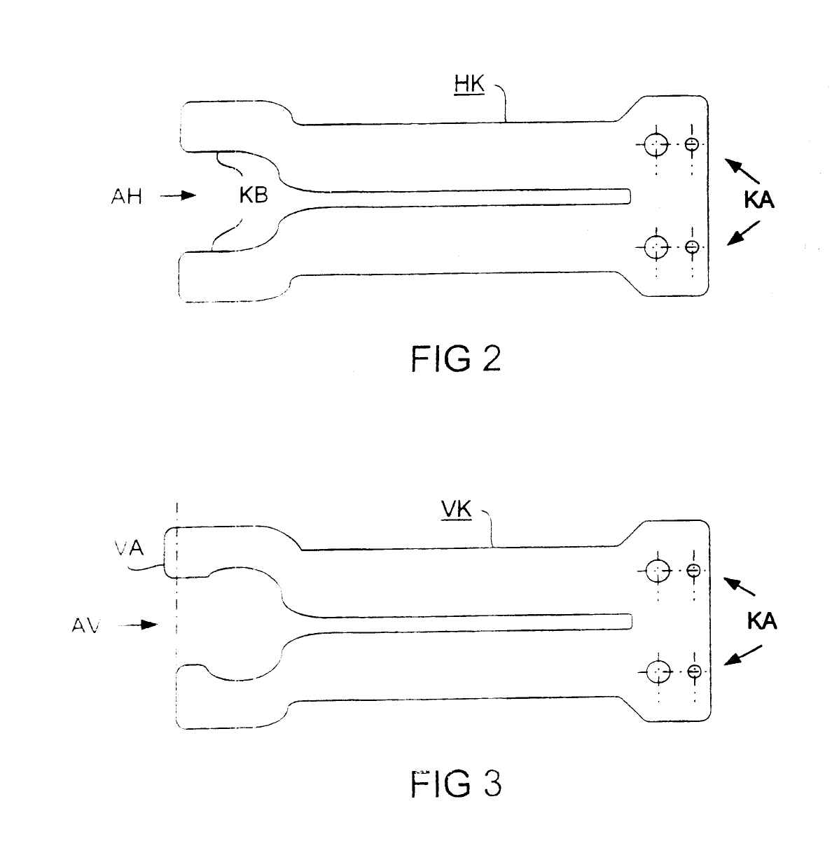

FIGS. 2 and 3 show details, in particular the contours, of the main contacts and of the leading contacts.

FIG. 1 shows the grounding switch, illustrated in perspective. In principle, contact is made in the grounding switch by the contact rod KS being inserted into the recesses AV, AH (FIGS. 2, 3) of the split contacts ZK. The split contacts ZK are distributed in the grounding switch such that two split contacts ZK which are located on the outside are in each case electrically conductively connected to the housing wall GW, which is at ground potential, and the three split contacts ZK which are arranged in between them and have the same configuration are provided for the pole connections, which are not illustrated.

As can also be seen, the coupling rod KS is bounded at each of the free end regions by the guide bolt FB, which is provided with the guide groove FN. The guide bolts FB are linearly positively guided by means of their guide grooves FN in the guide slots FS in the housing wall GW, so that, in order to make contact, the contact rod KS is inserted directly into the split contacts ZK, by means of the split link drive SA.

The split link drive SA is preferably designed such that the split links are located approximately in the extended position during the contact-making process, so that the high contact pressure is produced between the contact rod KS and the split contacts ZK without applying any significant additional force. This effect is additionally further reinforced by the contact pressure springs KF of the split link drive SA.

FIG. 2 shows, in particular, the contour of the main contacts HK, which are assembled from a number of individual sheets to form so-called contact laminates, depending on the required current-carrying capacity. In the region in which contact is made with the contact rod KS (FIG. 1), the main contacts HK are each provided with a recess AH which is terminated on the outside by two contact webs KB, which run parallel to one another, for making contact with and for guiding the contact rod KS (FIG. 1). The main contacts HK are slotted in the region of their longitudinal axis approximately as far as the contact connections KA, so that, when contact is being made with the contact rod KS (FIG. 1), a spring pressure force is produced in a known manner at right angles to the contact webs KB.

FIG. 3 shows the contour of the leading contacts VK, whose longitudinal slots extend as far as the contact connections KA, in the same way as in the main contacts HK (FIG. 2). Only the recesses AV in the leading contacts VK are designed to be functionally different. These are asymmetric with respect to their longitudinal axis such that the upper part contains an extension attachment VA in comparison to the lower part, which ensures, while making contact with the contact rod KS (FIG. 1), that the current flow first of all runs via the leading contact VK and only then via the main contact HK (FIG. 2) of the split contacts ZK (FIG. 1). During the contact-making process, the recesses AV in the leading contacts VK surround the cross-sectional contour of the coupling rod KS over half of its diameter, and thus form a large contact surface area, with a current-carrying capacity which is even sufficient for short circuits.

1. A contact arrangement for a grounding switch in switchgear assemblies for power supply and distribution, in particular for a fault making switch in medium-voltage switchgear assemblies, having two switching contacts which can move relative to one another and of which first switching contacts are in the form of a blade contact and further switching contacts are in the form of split contacts which are composed of U-shaped contact laminates, are arranged alongside one another and are electrically conductively connected to external contours of the blade contacts during the contact-making process,
characterized by the following features:
1.1 the blade contact is formed by a contact rod (KS) which preferably has a round cross-sectional contour,
1.2 the contact rod (KS) is bounded at each of its two ends by a guide bolt (FB) which overhangs the cross-sectional contour and is in each case provided with a guide groove (FN),
1.3 the guide bolts (FB) are linearly positively guided by the guide grooves (FN) in guide slots (FS) in a housing wall (GW) which provide the outer boundary for the contact arrangement,
1.4 the contact rod (KS) is moved toward the split contacts (ZK) by means of a split link drive (SA) with contact pressure springs (KF)

2. The contact arrangement for a grounding switch as claimed in patent claim 1,
characterized by the following features:
2.1 the split contacts (ZK) are formed from at least one leading contact (VK), and with a number of main contacts (HK) matched to the current load to be carried,
2.2 the split contacts (ZK) are distributed in the contact arrangement such that ground potential can be supplied via the split contacts (ZK) on the housing wall (GW) which provides the outer boundary, and the split contacts (ZA) which are enclosed between them are used as pole connections.

3. The contact arrangement for a grounding switch as claimed in patent claim 1 and patent claims 1 and 2,
characterized by the following feature:
3.1 the split contacts (ZK) are matched to the cross-sectional contour of the contact rod (KS) such that, when the contact rod (KS) is moved toward the split contacts (ZK), recesses (AV) in the leading contacts (VR) make contact with the split contacts (ZK) first of all, after which further recesses (AH) in the main contacts (HK) make contact with the split contacts (ZK).

4. The contact arrangement for a grounding switch as claimed in patent claim 3,
characterized by the following features:
4.1 the recesses (AV) in the leading contacts (VK) surround the cross-sectional contour of the contact rod (KS) over half of its diameter,
4.2 the recesses (AV) in the leading contacts (VK) are asymmetric with respect to their longitudinal axis such that the upper part projects by an extension attachment (VA) beyond the lower part,
4.3 the further recesses (AH) in the main contacts (HK) surround the cross-sectional contour of the contact rod (KS) by means of contact webs (KB), which run parallel to one another, while making contact,
4.4 the main contacts (HK) have a symmetrical contour with respect to their longitudinal axis.

5. The contact arrangement for a grounding switch as claimed in patent claim 4,
characterized by the following features:
5.1 the contact rod (KS) and the main contacts (HK) are produced from copper material,
5.2 the leading contacts (VK) are produced from sheet steel.
